(19) United States
(12) Patent Application Publication
(10) Pub. No.: US 2013/0339267 A1
(43) Pub. Date: Dec. 19, 2013

(54) System for the Electronic Exchange of Freight Documentation and Proof of Delivery Data

(71) Applicants: Mitch Hixon, Brentwood, TN (US); Kelley Walkup, Franklin, TN (US); Chad Goins, Highlands Ranch, CO (US); Michael Grolnic, Arvada, CO (US)

(72) Inventors: Mitch Hixon, Brentwood, TN (US); Kelley Walkup, Franklin, TN (US); Chad Goins, Highlands Ranch, CO (US); Michael Grolnic, Arvada, CO (US)

(73) Assignee: XEROX BUSINESS SERVICES, LLC, Dallas, TX (US)

(21) Appl. No.: 13/526,861

(22) Filed: Jun. 19, 2012

(51) Int. Cl. G06Q 10/08

(52) U.S. Cl. 705/341

(57) ABSTRACT

An information exchange system for handling shipment documentation and information, comprising an exchange server configured to process and exchange the shipment documentation and information for a plurality of parties comprising a carrier, a customer, and a third party and to communicate with an interface, a first terminal for the carrier, and a second terminal for the third party, wherein the interface is configured to electronically capture shipment documentation upon delivering shipment to the customer and forward the captured shipment documentation to the exchange server, wherein the first terminal is configured to receive the captured shipment documentation from the exchange server and forward shipment information of the carrier to the exchange server, and wherein the second terminal is configured to receive the shipment information of the carrier from the exchange server and forward additional shipment information of the third party to the exchange server.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Truckload shipping is the transportation and delivery of relatively large amounts of cargo, typically the amount necessary to fill an entire semi-trailer or intermodal container. A truckload carrier, also referred to as a full truckload carrier, is a trucking company that typically contracts an entire trailer-load to a single customer. For example, a full truckload carrier delivers a semi-trailer to a shipper who fills the trailer with freight for one destination. After the trailer is loaded, the driver collects from the shipper the required paperwork (e.g. bill of lading, invoice, customs paperwork, and/or other paperwork) and departs with the trailer containing freight for delivery. Less-than truckload shipping is the transportation of relatively small freight. A less-than truckload carrier is a trucking company that typically mixes freight from several customers in each trailer. For example, a less-than truckload carrier collects freight from multiple shippers and consolidates that freight onto an enclosed trailer for line-haul to a delivering hub, where freight is further sorted and consolidated for additional line-hauls. Parcel delivery, also referred to as package delivery, is the shipping of packages (parcels) or high value mail as single shipments. This service is provided by various postal systems, including private package delivery services and public postal services.

Currently, parcel carriers and less-than-truckload carriers are moving away from requiring or using paper-based proof of delivery by using handheld devices or other technologies to obtain proof of delivery, such as obtaining customer electronic signatures upon delivery. However, truckload carriers still rely substantially on paper-based transactions, such as mailing or faxing proof of delivery documentation by drivers to carrier offices. The paper-based transaction can cause various inefficiencies in the shipping process, including mail delays, missing or loss of paperwork, document inconsistencies, or other shortcomings of handling paper documents.

### SUMMARY

In an embodiment, the disclosure includes an information exchange system for handling shipment documentation and information, comprising an exchange server configured to process and exchange the shipment documentation and information for a plurality of parties comprising a carrier, a customer, and a third party and to communicate with an interface, a first terminal for the carrier, and a second terminal for the third party, wherein the interface is configured to electronically capture shipment documentation upon delivering shipment to the customer and forward the captured shipment documentation to the exchange server, wherein the first terminal is configured to receive the captured shipment documentation from the exchange server and forward shipment information of the carrier to the exchange server, and wherein the second terminal is configured to receive the shipment information of the carrier from the exchange server and forward additional shipment information of the third party to the exchange server.

In another embodiment, the disclosure includes an apparatus for exchanging shipment information and documentation comprising a processor configured to receive trip documentation information captured electronically and comprising proof of delivery data for a customer, exchange electronically the trip documentation information and shipment information comprising invoice information with a carrier associated with the customer, and exchange electronically the shipment information and additional shipment information comprising payment settlement information with a third party associated with the carrier.

In yet another embodiment, the disclosure includes a method implemented by a shipment information exchange system, comprising receiving image captured trip documentation from a driver for a carrier electronically upon delivering shipment to a customer, sending the image captured trip documentation to the carrier electronically upon receiving the image captured trip documentation, receiving shipment documentation data from the carrier electronically, sending the shipment documentation data to a third party electronically upon receiving the shipment documentation data, receiving payment settlement notification from the third party electronically, and sending the payment settlement notification to the carrier electronically upon receiving the payment settlement notification.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a shipping information exchange system.

FIG. 2 is a schematic diagram of another embodiment of a shipping information exchange system.

FIG. 3 is a flowchart of an embodiment of a shipping information exchange method.

FIG. 4 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The process of handling documentation by drivers upon delivery of shipment, such as proof of delivery and invoice documentation is referred to herein as front-end processing. Image capture technologies may be used to capture documentation by carrier drivers at the front-end. Document capture technologies may include truck document scanning by drivers at truck stops, in-cab scanning, third party (other than carrier or customer/shipper) outsourced scanning service bureaus, and/or in-house document scanning in the carrier back office. However, remaining aspects of the shipment process beyond the front-end, also referred to herein as back-end processing, remain substantially paper-based. While the initial capture of proof of delivery documentation has been improved or facilitated using image capture technologies, little or no significant effort is made to expedite the time at the back-end, e.g., the time elapsed from delivery and invoice creation to settlement. Typically, truckload carriers mail (or fax) a paper invoice (e.g., with supporting documents) to the shipper or third party for settlement of payment. The receiving party may then scan or save the documents into their back office systems and approve payments to carriers. Some shippers may use the mail process to obtain the necessary documentation as a means to intentionally delay payment back to the carrier as a business practice. However, this paper-based process has significant inefficiencies that may outweigh the benefit from delaying payment.

Disclosed herein is a system and method for improving the efficiency and timeliness for truckload freight shipment transactions, and hence reduce overall cost and allow faster payment settlement between the concerned parties. The system and method may be used for truckload shipping, and similarly for less-than truckload shipping, or other suitable shipping scenarios (e.g., that comprise similar shipping entities). The system and method may comprise imaging the shipping documents once and subsequently delivering the imaged documents to one or a plurality of parties in the supply chain, which may require the imaged documents and/or other relevant documentation (e.g., proof of delivery, invoice, rate confirmation, or other necessary shipment paperwork). The parties may comprise drivers that forward the imaged documentation and carriers, shippers, and/or third parties that require documentation, such as for billing, settlement of activities, internal processing, or other purposes.

The system may comprise one or more exchange servers (e.g., at a data center) configured to receive, store, and maintain the imaged documentation, which may be submitted by drivers electronically. The exchange server(s) may process and forward the imaged documentation and other relevant documentation to the corresponding parties electronically. The system may remove or reduce the burden and cost of redundant processing of documents for different parties, improve the consistency and accuracy of distributed data, and improve timeliness (e.g., speed up data exchange among parties) using electronic communications instead of paper delivery or mail. The system may also improve visibility to different aspects of the process by promptly reporting (in real-time or near-time) to concerned parties status of freight shipments and payment settlement notifications.

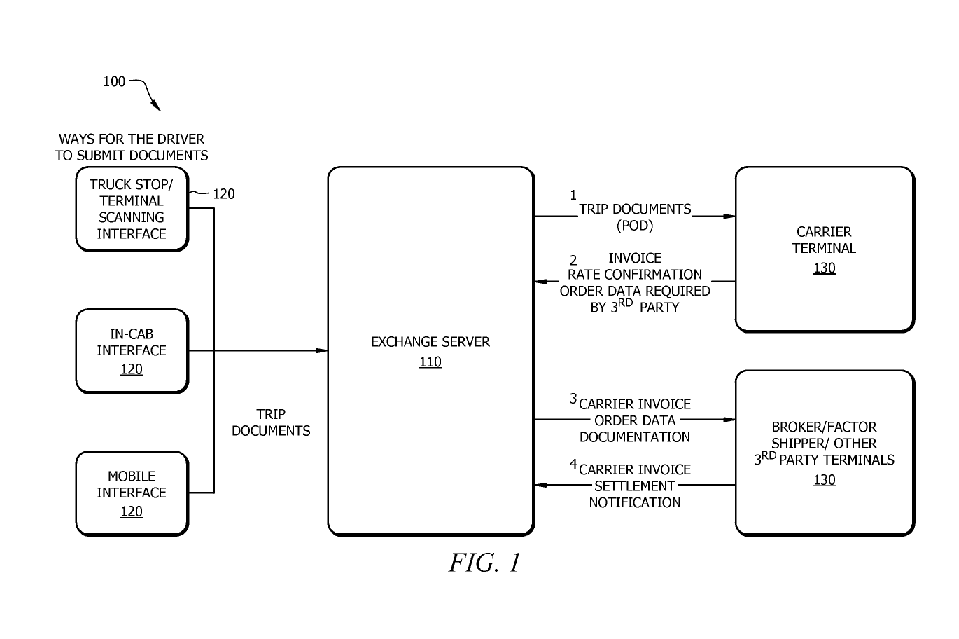

FIG. 1 illustrates an embodiment of a shipping information exchange system 100 that may be implemented for improving the efficiency and timeliness of the shipment process. The shipping information exchange system 100 may be used for truckload shipping, less-than truckload shipping, parcel shipping, or other motor carrier shipping scenarios. The shipping information exchange system 100 may comprise at least one exchange server 110, one or more interfaces 120 coupled to the exchange server 110, and a plurality of terminals 130 coupled to the exchange server 110. The shipping information exchange system 100 may comprise any number of such components, which may be arranged as shown in FIG. 1.

The exchange server 110 may be any component, device, or apparatus configured to process, store, and exchange shipment data with the interfaces 120 and the terminals 130, as described below. For instance, the exchange server 110 may be a physical sever or a general purpose computer, e.g., at a data center or a network. The exchange server 110 may also be coupled to one or more storage devices (not shown), which may be configured to store and maintain the shipment data, e.g., in one or more databases corresponding to one or more parties. For example, the storage devices may comprise one or more hard disks, temporary memory devices, portable memory devices, and/or other digital data storage technologies. The exchange server 110 may be coupled to the interfaces 120 and the terminals 130 via corresponding links directly or through one or more networks (not shown). The links may include electrical links (e.g., cable, twisted pairs), optical links (e.g., optical fiber), wireless links (e.g., cellular, Wireless Fidelity (WiFi)), or combinations thereof. In an embodiment, a plurality of exchange servers 110, e.g., in one or more data centers and/or networks, may be used to process, store, and exchange shipment data, e.g., in a distributed manner.

The interfaces 120 may be any components, devices, or apparatuses configured to capture shipping data, including the capturing or scanning of images and text (e.g., capturing images of paper documents, scanning barcodes) or otherwise electronically entered data (e.g., electronic signatures, keyed in data). The shipping data may be for trip related documents, proof of delivery (POD) documents, bill of lading information, invoice information, customs documents, rate confirmation information, and/or other shipment related information (e.g., related to customers or any of the other parties). The interfaces 120 may be hand-held or mobile devices, in-cab devices, or on-site devices, which may be operated by a driver (truck driver), a shipper, or an individual customer to enter shipment information. For example, the interfaces 120 may comprise a scanning terminal (e.g., coupled to a desktop computer) at a truck stop, an in-cab apparatus (e.g., a laptop or tablet computer) for entering data (via a keyboard or a touchscreen), a mobile device (e.g., a smartphone or tablet computer) for image capturing data (via a built-in camera). The interface 120 may send the captured or entered information to the exchange server 110 and may also receive data from the exchange server 110, such as confirmation data, shipment transaction data (intended for drivers and/or customers), address/mapping data, customer data, or other communications.

The terminals 130 may correspond to a plurality of parties involved in the shipping process, including one or more carriers, shippers, brokers, factors, shippers, other third parties, or combinations thereof. The carriers may be any type of truckload carriers (e.g., full truckload carriers, less-than truckload carriers, and/or parcel carrier) that operate trucks and truck drivers to deliver shipment for customers. The shippers may be customers of the carriers that hire the carriers to deliver shipment. The shippers may also be hired by other customers, such as businesses and/or individuals, to ship corresponding freight, parcels, merchandise, packages, and/or other items. For instance, a shipper may be hired by a plurality of businesses to ship a plurality of corresponding items. The carriers may deliver a truckload or less of items for different customers (e.g., businesses) to a delivering hub. The shipper may then pick up the items from the delivering hub and deliver the different items to the different customers (e.g., businesses). The agents may be middle parties between shippers and carriers, for instance that are hired by shippers to deliver items and in turn hire carriers to do so. The factors may be middle parties between shippers and other customers (e.g., businesses/individuals), for instance that are hired by the customers to ship corresponding items and in turn hire shippers to do so. Other third parties may include logistics providers and/or other middle parties that operate between the parties above.

The terminal 130 may be any component, device, or apparatus configured to receive shipping information from the exchange server 110. The terminals 130 may receive the information automatically from the exchange server 110, e.g., when the information is available and ready to be sent from the exchange server 110. For instance the terminals 130 may be part of office systems or information management systems that correspond to the parties. Examples of the terminals 130 include general purpose computers (desktop/laptop computers, mini-frames, etc.), servers, network nodes, other communications and processing equipment, or combinations thereof. The exchanged shipping information may include trip documents, invoice documents, and/or order data relevant to the corresponding parties, which may have authorization (by the shipping information exchange system 100) to receive or access such information.

Using the components above, the shipping information exchange system 100 may capture freight/proof of delivery documentation electronically, add associated content to the captured information (e.g., invoices and rate confirmations), and share that information electronically with authorized parties. The freight/proof of delivery documentation may be captured for freight and carriers of any sizes, e.g., for truckload shipping and less-than truckload shipping. Thus, both small and large carriers may reap similar benefits, and benefit their drivers and customers.

Specifically, drivers for carriers may capture or scan proof of delivery/invoice documents or paperwork using the interfaces 120. The information may be captured for different customers (e.g., individual customers or shippers). The captured information may be sent to the exchange server 110 (or a plurality of exchange servers 110), where the information may be indexed and stored. The exchange server 110 may store the captured information in one or more corresponding databases that belong to one or more parties (e.g., carriers, shippers, brokers, and/or other third parties). The exchange server 110 may optionally add associated content to the received information from the interfaces 120, such as indexing information, shipping/delivery time information, customer information, carrier information, other parties information, record keeping information, customs information, and/or other necessary shipping information.

The exchange server 110 may then send images or electronic copies of the captured documents and optionally any added information to the corresponding terminals 130 of the carriers and other parties, e.g., automatically upon receiving and processing the captured documents data. In some embodiments, the carriers and other parties may also be allowed to access the stored information (e.g., in one or more databases of the exchange server 110) via the terminals 130. The carriers and other parties may use the received information from the exchange server 110 for workflow/billing processes. For instance, after receiving (or accessing) the documents and information electronically, the brokers, shippers, and other third parties may bill their customers and release carrier payment settlements.

In one scenario, the exchange server 110 may receive trip documents (e.g., including proof of delivery) from the drivers via the interfaces 120 and send the trip documents to one or more corresponding carriers via the terminals 130. The trip documents for one or a plurality of trips may be sent to a corresponding carrier as a single document or a package of documents that may be indexed. This packaging of trip documents may improve the efficiency of data forwarding and reduce the chances of losing trip data. For example, a package of documents may be combined in a folder, a compression format, or other electronic file grouping formats and may be sent to a corresponding carrier on regular basis, e.g., on daily basis. The package of documents (or folder of files) may be labeled to indicate a common date of all the documents (or files).

The exchange server 110 may then receive documents from the carriers, such as invoices, rate confirmation, and/or other data required by the shippers and third parties (e.g., brokers, factors, or others). A plurality of documents may be received from the same carrier in a package (e.g., a folder of document files), e.g., on regular basis. The exchange server 110 may forward the carrier documents to the shippers and third parties via the terminals 130. A plurality of carrier documents may be forwarded to a corresponding shipper or third party as a package, e.g., on regular basis. The shippers and third parties may in return send carrier settlement notifications to the exchange server 110, which may relay the notifications to the carriers. A plurality of carrier settlement notifications may be forwarded from a corresponding shipper or third party as a package (e.g., a folder of document files), e.g., on regular basis. The exchange server 110 may process the received data before further forwarding the data to the parties. The exchange server 110 may forward the information to the corresponding parties in an automated manner without substantial delays, which may accelerate the shipment information exchange in the supply chain.

The shipping information exchange system 100 may provide a plurality of advantages to carriers. As described above the shipping information exchange system 100 may allow the carrier's drivers to submit documentation at truck stops and from other convenient locations, such as from inside the cab, which may facilitate some operations and transactions for drivers and improve their work environment. Indexed documents and related data for carriers may also be sent electronically to other parties, which may allow carriers to receive payment settlements faster. The electronic exchange may also allow the other parties, e.g., shippers, brokers, and other third parties (e.g., logistics providers) to bill customers or receive payments from customers faster (e.g., after proof of delivery). Thus, the average collection period for concerned parties may be reduced. The electronic exchange of information without handling and dealing with paper based documents (except to initially capture such documents) across the entire supply chain from customers to carriers and other parties may eliminate or reduce errors due to paperwork processing. As described above, the processes of the shipping information exchange system 100 may be completely or substantially automated, i.e., implemented without human or manual processing of data except for initially capturing shipment information by drivers upon delivery. Further, the carriers may send rate confirmation, invoice, and bills of landing together to the corresponding parties via the exchange server 110, which may reduce the chances for lost or inconsistent information. The electronic exchange of shipping information with the different parties may also eliminate the time and cost of mailing or faxing invoices or other shipment information to parties, such as brokers, shippers, and other third parties.

The shipping information exchange system 100 may also allow brokers, factors, shippers, and other third parties to get paid faster. Since these parties may receive proof of delivery faster electronically in comparison to waiting for paper documents by mail, the parties may start their invoice cycle (to customers) faster. The system may also offer brokers and other third parties a relatively easy and consistent method of receiving and processing invoices and freight documents from carriers, which may allow such parties to bill shippers or individual customers faster. For example, providing same-day electronic receipts of proof of delivery and invoices may eliminate the need for manual indexing, improve efficiency, save time and money, and speed cash flow.

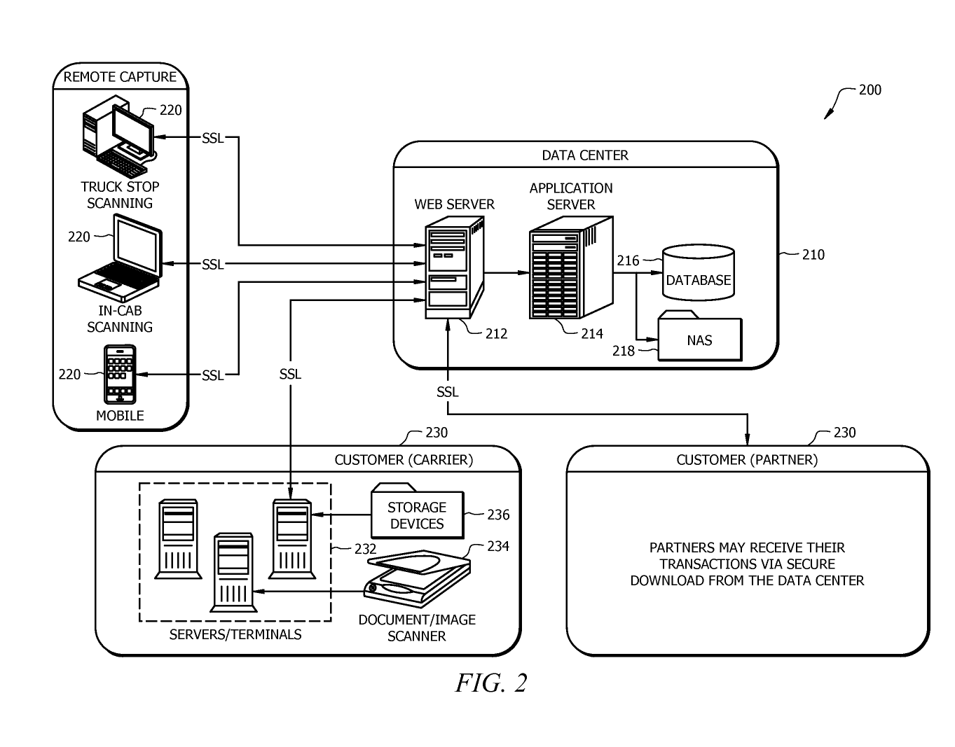

FIG. 2 illustrates an embodiment of another shipping information exchange system 200, which may improve the efficiency and timeliness of the shipment process. The shipping information exchange system 200 may comprise an exchange data center 210, one or more interfaces 220 coupled to the exchange data center 210, and a plurality of customer systems 230 coupled to the exchange data center 210. The shipping information exchange system 200 may comprise any number of such components, which may be arranged as shown in FIG. 2.

The exchange data center 210 may be configured to exchange, process, and store data with the interfaces 220 and customer systems 230. The exchange data center 210 may comprise a web server 212, and application server 214, a local database 216, and optionally a network attached storage (NAS) 218, which may be coupled to each other as shown in FIG. 2. The web server 212 may be configured to exchange shipment information with the interfaces 220 and the exchange customer systems 230 via network communications (e.g., the Internet) as described above. For example, the web server 212 may use a secure socket layer (SSL) protocol over the Internet or other networks to exchange the information with the other components. The application server 214 may be configured to process the information, e.g., to add additional content as described above. The web server 212 and application server 214 may be physical severs (hardware) or applications (software) that are implemented on one or more physical servers. The database 216 may be a data structure (software) that maintains the received or processed information. The database 216 may be stored locally in a storage device, such as described above. The NAS 218 may comprise one or more storage devices at one or more remote or network locations (e.g., at the Internet or other locations).

The interfaces 220 may be configured substantially similar to the interfaces 120 to capture and exchange shipment data with the exchange data center 210. The customer systems 230 may correspond to a plurality of parties involved in the shipping process, including one or more carriers, shippers, brokers, and/or other third parties. The customer systems 230 may be configured to exchange shipping information with the exchange data center 210. The customer systems 230 may comprise one or more servers/terminals 232 that are configured similar to the terminals 130. Additionally, the servers/terminals 232 may process the received documentation from the exchange data center 210. Users (e.g., for carriers) may use the servers/terminals 232 to review documents and share information with other parties or partners (e.g., shippers, brokers, other third parties) via the exchange data center 210. The documents and related data may be stored and accessed remotely at the exchange data center 210, as described above. The customer systems 230 may also comprise a document/image scanner 234 or similar devices configured to scan documents by users and send the scanned data to the servers/terminals 232. The customer systems 230 may also comprise one or more local storage devices 236 configured to upload documents data stored by users to the servers/terminals 232.

In some embodiments, the customer systems 230 that belong to carriers may access the exchange data center 210 (e.g., the web server 212) via a secure website to obtain carrier associated information. Other customer systems 230 that belong to other parties or carrier partners may receive their information via a secure download or other available communications means (e.g., email) from the exchange data center 210. Enabling the exchange data center 210 to communicate substantially all shipment information with each customer system 230 (for carriers and other parties), for example instead of allowing inter-exchanges between the parties, may provide better control, efficiency, and timeliness.

The shipping information exchange systems 100 and 200 may provide cost and time savings by eliminating the need of mailing paper invoices for the carriers and in some scenarios for third party logistics providers. The systems may also provide additional cost and time savings by eliminating the need of scanning paper invoices for shippers and in some scenarios for third party logistics providers. As described above, timeliness of the shipment information exchange down the supply chain may be improved. For instance, invoices and proof of delivery may be generated and available electronically within minutes of load delivery. The systems may also improve both internal and external average collection period for motor or truck carriers, e.g., as calculated by Days Sales Outstanding (DSO).

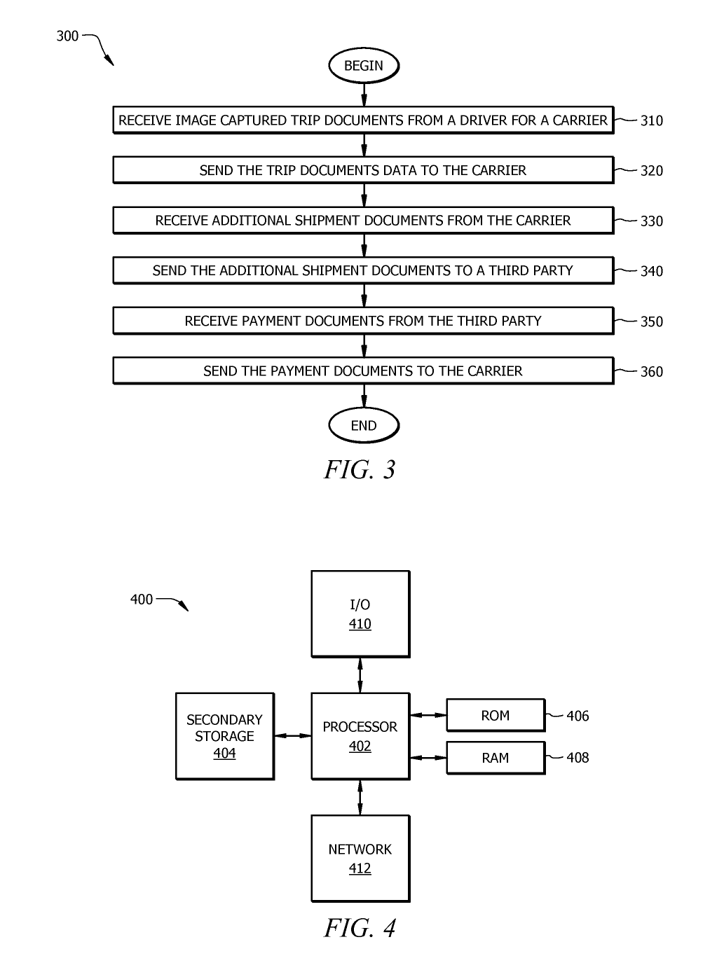

FIG. 3 illustrates an embodiment of a shipping information exchange method 300 that may be implemented in the shipping information exchange system 100 or 200 to improve the efficiency and timeliness for truckload freight shipment transactions. For instance, the shipping information exchange method 300 may be implemented by the exchange server 110 or the exchange data center 210. The method 300 may begin at block 310, where image captured trip documents may be received from a driver for a carrier. The documents may be received electronically from the driver upon shipment delivery and imaging of paper delivery documents using the interfaces 120 or 220. The documents may comprise proof of delivery documents, invoices, trip related documents, bill of landing documents, customs documents, rate confirmation documents, and/or other shipment or delivery information. At block 320, the trip documents data may be sent to the carrier. The documents may be sent electronically and automatically when ready (e.g., after processing) via a terminal 130 or a customer system 230.

At block 330, additional shipment documents may be received from the carrier. The additional documents may be received electronically from the carriers via the terminal 130 or the customer system 230. The additional documents may comprise invoices, rate confirmation, and/or other data required by the shippers and third parties (e.g., brokers, factors, or others). At block 340, the additional shipment documents may be sent to a third party. The additional documents may be sent electronically and automatically to the third party via a corresponding terminal 130 or customer system 230. At block 350, payment documents may be received from the third party. For example, the third party may send the exchange server 110 or the exchange data center 210 payment settlement notification for the carrier. At block 360, the payment documents may be sent to the carrier. The method 300 may then end. In some embodiments, the carrier or third party may receive associated information after sending a request to the exchange server 110 or the exchange data center 210 or may access authorized information at the system database(s). This may further improve visibility to different aspects of the process to concerned parties.

The components described above may be implemented on any general-purpose network component, such as a computer or mobile device with sufficient processing power, memory resources, and network throughput capability to handle the necessary workload placed upon it. FIG. 4 illustrates a typical, general-purpose network component 400 suitable for implementing one or more embodiments of the components disclosed herein. The network component 400 includes a processor 402, e.g., a central processing unit (CPU), which is in communication with memory devices including secondary storage 404, read only memory (ROM) 406, random access memory (RAM) 408, input/output (I/O) devices 410, and network connectivity devices 412. The processor 402 may be implemented as one or more central processing unit (CPU) chips, or may be part of one or more application specific integrated circuits (ASICs) and/or digital signal processors (DSPs). The processor 402 may be configured to implement or support the schemes above of the shipping information exchange system 100 or 200 and the shipping information exchange method 300.

The secondary storage 404 is typically comprised of one or more disk drives or tape drives and is used for non-volatile storage of data and as an over-flow data storage device if RAM 408 is not large enough to hold all working data. Secondary storage 404 may be used to store programs that are loaded into RAM 408 when such programs are selected for execution. The ROM 406 is used to store instructions and perhaps data that are read during program execution. ROM 406 is a non-volatile memory device that typically has a small memory capacity relative to the larger memory capacity of secondary storage 404. The RAM 408 is used to store volatile data and perhaps to store instructions. Access to both ROM 406 and RAM 408 is typically faster than to secondary storage 404.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 7, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 7 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. The use of the term about means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While serveral embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An information exchange system for handling shipment documentation and information, comprising:
an exchange server configured to process and exchange the shipment documentation and information for a plurality of parties comprising a carrier, a customer, and a third party and to communicate with an interface, a first terminal for the carrier, and a second terminal for the third party,
wherein the interface is configured to electronically capture shipment documentation upon delivering shipment to the customer and forward the captured shipment documentation to the exchange server,
wherein the first terminal is configured to receive the captured shipment documentation from the exchange server and forward shipment information of the carrier to the exchange server, and
wherein the second terminal is configured to receive the shipment information of the carrier from the exchange server and forward additional shipment information of the third party to the exchange server.

2. The information exchange system of claim 1, wherein the shipment documentation and information for the parties are exchanged between the exchange server, the interface, the first terminal, and the second terminal electronically without handling paper based documentation.

3. The shipment information exchange system of claim 1, wherein the captured shipment documentation comprises proof of delivery documentation, the shipment information of the carrier comprises invoice and rate confirmation documentation, and the additional shipment information of the third party comprises payment settlement notification.

4. The information exchange system of claim 1 further comprising a storage medium coupled to the exchange server and configured to maintain one or more databases for storing the shipment documentation and information for the parties, provide the carrier authorized and secured access to the captured shipment documentation, and provide the third party secured download of the shipment information of the carrier.

5. The shipment information exchange system of claim 1, wherein the interface is a mobile device that is operated by a driver of the carrier to generate and forward the electronically captured shipment documentation upon delivering shipment to the customer.

6. The shipment information exchange system of claim 1, wherein the interface is an in-cab device in a motor vehicle that is operated by a driver of the carrier to generate and forward the electronically captured shipment documentation upon delivering shipment to the customer.

7. The shipment information exchange system of claim 1, wherein the interface is a scanning terminal at a shipment delivery location that is operated by a driver of the carrier to generate and forward the electronically captured shipment documentation upon delivering shipment to the customer.

8. The shipment information exchange system of claim 1, wherein the exchange server is configured to implement a web server that securely communicates with the interface, the first terminal, and the second terminal, and an application server that processes the shipment documentation and information for the parties to add relevant data including indexing information.

9. The shipment information exchange system of claim 8, wherein the web server, the application server, or both are coupled to at least one of a database storage for locally storing the shipment documentation and information for the parties, and a network attached storage (NAS) for remotely storing the shipment documentation and information for the parties.

10. The shipment information exchange system of claim 1, wherein the exchange server is further configured to provide shipment logistics to the carrier, the third party, or both.

11. The shipment information exchange of claim 1, wherein the third party is a shipper, a broker, or a logistics provider that is a business partner of the carrier.

12. The shipment information exchange system of claim 1, wherein the first terminal, the second terminal, or both are configured to couple to at least one of a scanner that image captures documentation, and a local storage medium that stores and uploads data to the exchange server.

13. An apparatus for exchanging shipment information and documentation comprising a processor configured to:
receive trip documentation information captured electronically and comprising proof of delivery data for a customer;
exchange electronically the trip documentation information and shipment information comprising invoice information with a carrier associated with the customer; and
exchange electronically the shipment information and additional shipment information comprising payment settlement information with a third party associated with the carrier.

14. The apparatus of claim 13, wherein the processor is further configured to process the trip documentation information, the shipment information, the additional shipment information, or combinations thereof to provide indexing information to the carrier, the third party, or both.

15. The apparatus of claim 13, wherein the process is further configured to process the trip documentation information, the shipment information, the additional shipment information, or combinations thereof to provide logistics information to the carrier, the third party, or both.

16. The apparatus of claim 13, wherein the trip documentation information, the shipment information, and the additional shipment information is sent promptly when received without substantial delay and processing.

17. The apparatus of claim 13, wherein the trip documentation information, the shipment information, and the additional shipment information is exchanged without paper based communications and without direct communications between the customer, the carrier, and the third party.

18. A method implemented by a shipment information exchange system, comprising:
receiving image captured trip documentation from a driver for a carrier electronically upon delivering shipment to a customer;
sending the image captured trip documentation to the carrier electronically upon receiving the image captured trip documentation;
receiving shipment documentation data from the carrier electronically;
sending the shipment documentation data to a third party electronically upon receiving the shipment documentation data;
receiving payment settlement notification from the third party electronically; and
sending the payment settlement notification to the carrier electronically upon receiving the payment settlement notification.

19. The method of claim 18, wherein the image captured trip documentation comprises proof of delivery (POD) information, bill of lading information, invoice information, customs documents, or combinations thereof.

20. The method of claim 18, wherein the shipment documentation data is scanned, uploaded, or both from the carrier, and wherein the shipment documentation data is sent to the third party using secured download without manual or human intervention.

21. The method of claim 18, wherein the payment settlement notification is scanned, uploaded, or both from the third party, and wherein the payment settlement notification is sent to the carrier using secured download without manual or human intervention.

22. The method of claim 18, wherein the image captured trip documentation, the shipment documentation data, and the additional shipment documentation data are received and sent via a secure socket layer (SSL) protocol over the Internet or one or more networks.
